(19) United States
(12) Patent Application Publication
(10) Pub. No.: US 2023/0191803 A1
(43) Pub. Date: Jun. 22, 2023

(54) MACHINE AND METHOD FOR THE DIGITAL DECORATION OF PRODUCTS WITH GRANULAR MATERIALS AND THE LIKE

(71) Applicant: PROBONO S.r.l., Modena (IT)

(72) Inventor: Alberto MALATESTA, Modena (IT)

(73) Assignee: PROBONO S.r.l., Modena (IT)

(21) Appl. No.: 17/926,871

(22) PCT Filed: May 27, 2021
(86) PCT No.: PCT/IB2021/054628

§ 371 Date: Nov. 21, 2022

(30) Foreign Application Priority Data
May 29, 2020 (IT) 102020000012958

(51) Int. Cl. B41J 11/00; B41J 3/407

(52) U.S. Cl. CPC B41J 11/0021; B41J 3/407

(57) ABSTRACT

A machine for the digital decoration of products with granular materials and the like, comprises: a basic frame; at least one supporting surface for supporting at least one product to be decorated associated with the basic frame; at least a first digital printing head adapted to apply at least a first layer of fluid adhesive material on the surface of the product to be decorated; a deposition component/device/unit/circuit or the like of a granular material on the first layer of adhesive material; a removal component/device/unit/circuit or the like of the excess granular material; at least a second digital printing head adapted to apply at least a second layer of fluid adhesive material on top of the granular material, the second printing head being positioned between the deposition component/device/unit/circuit or the like and the removal component/device/unit/circuit or the like.

### TECHNICAL FIELD

The present invention relates to a machine and method for the digital decoration of products with granular materials and the like.

### BACKGROUND ART

In some industries, such as e.g. the ceramics sector, the product surfaces are generally subjected to decoration processes aimed at giving the final product the desired aesthetic appearance.

As is well known, in the particular sector of ceramic tiles, the visible surfaces of the products are decorated in order so as to obtain the most varied aspects, with applications of layers of decorative material, such as e.g. inks, glazes and the like, but also materials in granular form such as powders and the like, usually of rather reduced thickness and necessary to obtain a substantially flat decoration, or at most having elements, such as slight reliefs or streaks, obtained with known technologies.

The need is, however, increasingly felt both in the ceramic sector and in other manufacturing sectors, to obtain textured surfaces, i.e. with portions in relief so as to give the manufactured article thus decorated a three-dimensional and material aspect.

This effect can, e.g., be achieved by the deposition in succession of a plurality of layers of the decorative material.

These decorative processes do have some drawbacks.

They, for example, may result in excessive waste of material due to the consecutive deposition of a plurality of layers of material.

In addition, it is difficult to control the thickness thus obtained on the manufactured article to be decorated, which may therefore be excessively high or low.

### DESCRIPTION OF THE INVENTION

The main aim of the present invention is to devise a machine and a method for the digital decoration of products with granular materials and the like that allow overcoming the drawbacks of the prior art.

Within this aim, one object of the present invention is to minimize the waste of the material used for the decoration of the manufactured article and, at the same time, to effectively and practically control the thickness of the decoration made. Another object of the present invention is to devise a machine and a method for the digital decoration of products with granular materials and the like, which allows overcoming the aforementioned drawbacks of the prior art within a simple, rational, easy, effective to use and affordable solution.

The aforementioned objects are achieved by the present machine for the digital decoration of products with granular materials and the like according to claim 1. The aforementioned objects are also achieved by the present method for the digital decoration of products with granular materials and the like according to claim 10.

### BRIEF DESCRIPTION OF THE DRAWINGS

Other characteristics and advantages of the present invention will become more apparent from the description of a preferred, but not exclusive, embodiment of a machine for the digital decoration of products with granular materials and the like, illustrated by way of an indicative, yet non-limiting example, in the accompanying tables of drawings wherein:

FIG. 1 is an axonometric view of a machine according to the invention, in a first embodiment;

FIG. 2 is a cross-sectional view of the machine in FIG. 1;

FIG. 3 is a magnifying view of a detail of the section in FIG. 2;

FIG. 4 is a schematic representation of the machine in FIG. 1;

FIG. 5 is a schematic representation of a machine according to the invention, in a second embodiment;

FIG. 6 is a schematic, axonometric representation of the first application of a first layer of adhesive material along a predefined path on a product to be decorated;

FIG. 6a is a cross-sectional view of the product in FIG. 6 along the predefined path;

FIG. 7 is a schematic, axonometric representation of the deposition of the granular material on the product to be decorated;

FIG. 7a is a cross-sectional view of the product in FIG. 7 along the predefined path;

FIG. 8 is a schematic, axonometric representation of the second application of a second layer of adhesive material over the product in FIG. 7;

FIG. 8a is a cross-sectional view of the product in FIG. 8 along the predefined path.

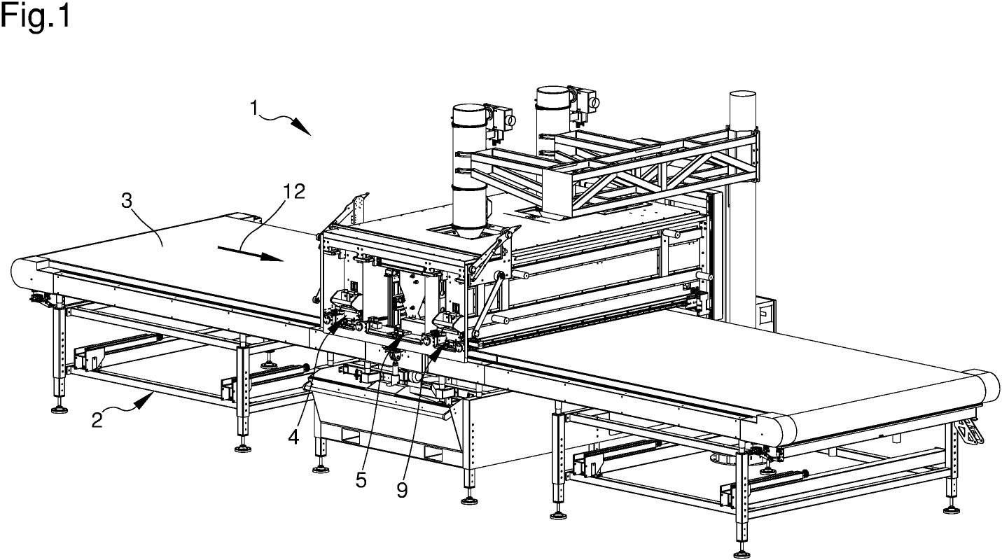

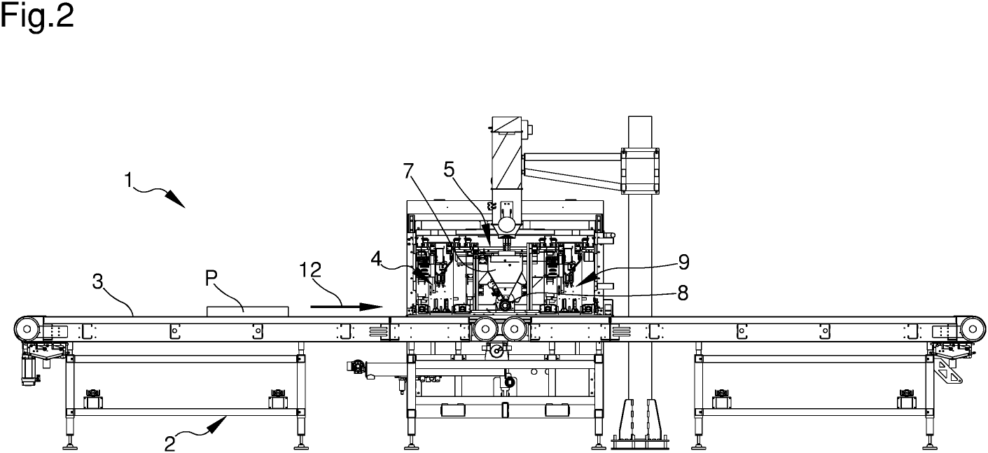

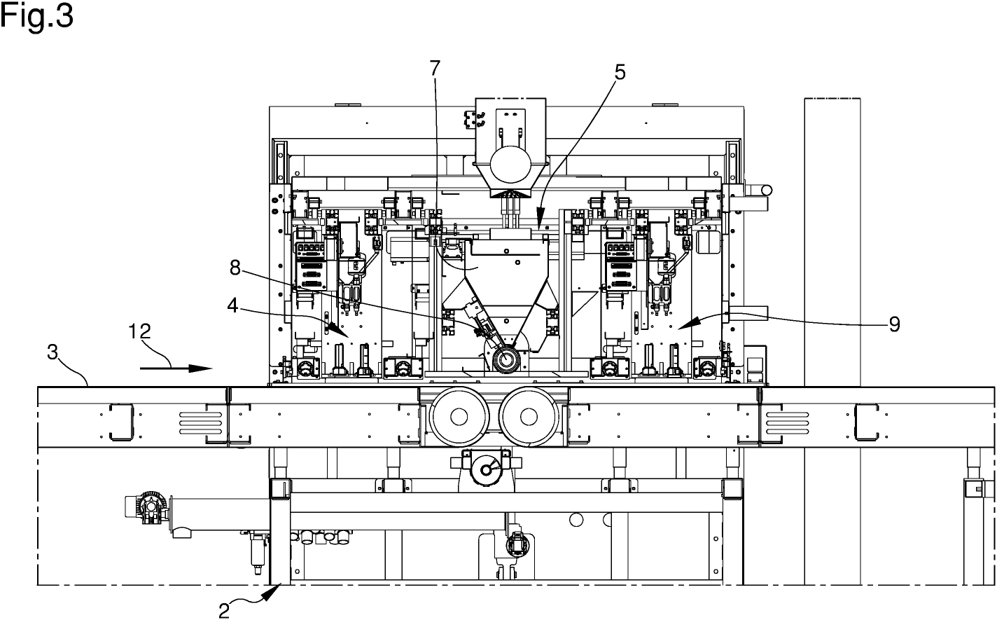

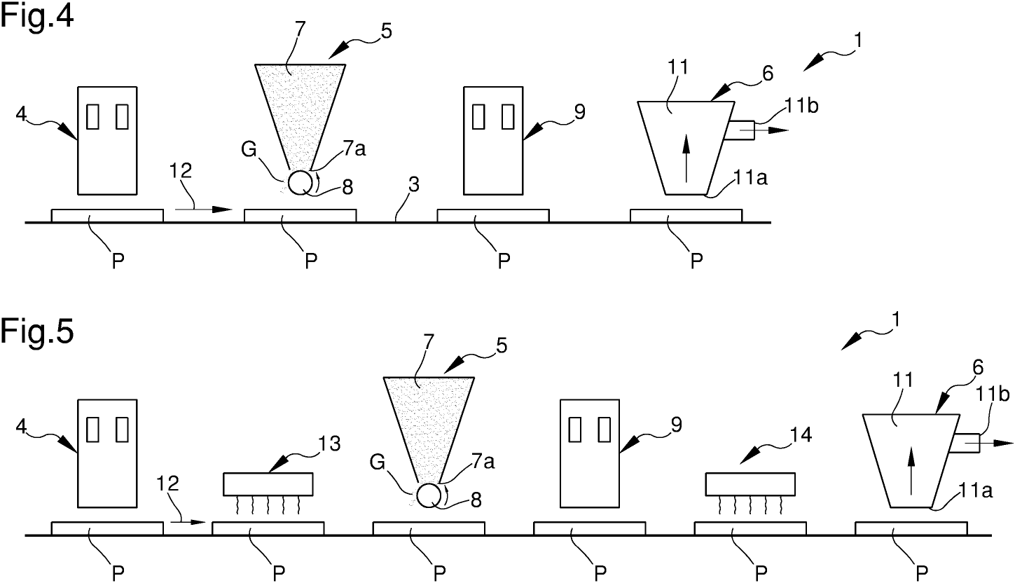

### EMBODIMENTS OF THE INVENTION

With particular reference to such figures, reference numeral 1 globally indicates a machine for the digital decoration of products with granular materials and the like.

It should, however, be noted that the machine could also be used to decorate products of any other nature, i.e., of any shape, including non-flat, and made of any material, without any limitation to the objects of the present invention.

The machine 1 comprises a basic frame 2 and at least one supporting surface 3 for supporting at least one product P to be decorated associated with the basic frame 2.

The machine 1 also comprises at least a first digital printing head 4 adapted to apply at least a first layer S′ of fluid adhesive material on the surface of the product P, deposition means 5 of a granular material G on the first layer S′ of adhesive material and removal means 6 of the excess granular material G.

The granular material G released by the removal means 6 then adheres to the product P through the first layer S′.

In particular, the granular material G to be deposited on the layer of adhesive material may comprise powders, granules, grits, flakes and the like, or any other material in granular or substantially granular form suitable for making a decoration on the surface of a product P having a certain thickness.

Advantageously, the deposition means 5 comprise at least one hopper 7 containing the granular material G and a dispensing device 8 of the granular material on the relevant layer S′ of adhesive material.

More specifically, the hopper 7 has at least one outlet port 7a of the material and the dispensing device 8 comprises at least one rotating element arranged below the outlet port 7a.

Such a rotating element 8, e.g. of the type of a cylindrical element, is adapted to drag in rotation the granular material G coming out of the outlet port so as to dispense it on the surface of the product P to be decorated. The rotating element 8 allows obtaining a uniform deposition of the granular material G on the various areas of the first layer S′.

Conveniently, the rotating element 8 is arranged at the outlet port 7a and is operable in rotation so as to drag the granular material G passing through the outlet port itself towards the first head 4.

It cannot however be ruled out that the rotating element 8 may also rotate in a discordant direction to that described above.

In addition, alternative embodiments cannot be ruled out wherein the dispensing device 8 is of the type of a vibrating element or of a chute.

According to the invention, the machine 1 comprises at least a second digital printing head 9 adapted to apply at least a second layer S″ of fluid adhesive material on top of the granular material G. The second head 9 is positioned between the deposition means 5 and the removal means 6.

The second layer S″ then overlaps with the granular material G, which is thus incorporated between the layers S′ and S″ of adhesive material to define a kind of sandwich. The mutual overlapping of the layers S′ and S″ and the granular material G results in an increase in thickness with respect to the surface to be decorated of the product P.

Each of the printing heads 4, 9, more particularly, is provided with one or more respective heads, which in turn are provided with relevant ejection nozzles (not visible in detail in the figures) for ejecting the fluid adhesive material onto the upper surface of the products P to be decorated.

In order to be delivered from the ejection nozzles of the printing heads 4, 9, the adhesive material should be of the low viscosity type.

It should be noted that the digital printing heads of this type are already used in the ceramic tile decoration industry, and in other similar sectors, mainly for the application of inks or other printing fluids.

Each head of the printing head 4, 9 is adapted to dispense, by means of ejection nozzles, e.g. piezoelectrically controlled, a controlled amount, in the unit of time, of micro-drops of fluid of various nature intended to be deposited on the surface of the product.

In other words, it is possible to deposit with the utmost precision, by means of such digital printing heads 4, 9, the layer of adhesive material even only on some areas of the surface of the product P to be decorated, according to a desired pattern and depending on the type of final decoration to be obtained: the layer of adhesive material may therefore be substantially continuous and even, or made up of several separate portions applied in the desired areas.

The digital printing heads 4, 9 can then apply the relevant layers S′, S″ of adhesive material either full-field, i.e., so as to cover the entire surface of the product P to be decorated, or following a predefined path 10.

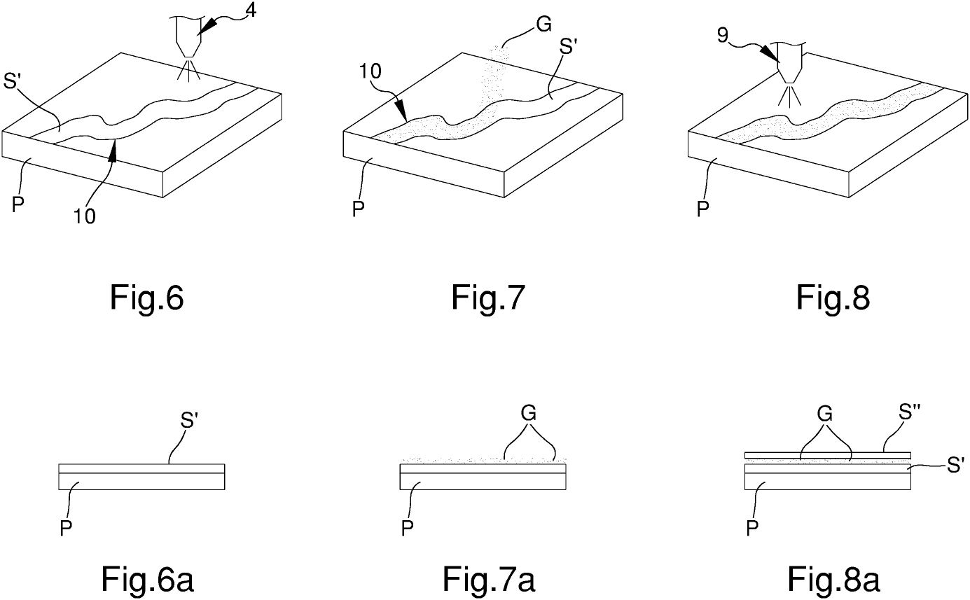

In the event of the first head 4 applying the relevant first layer S′ according to a predefined path 10, as shown in FIG. 6, the second head 9 applies the second layer S″ by following the same path 10. In this case it is immediately understandable for the technician in the sector that the product P has, along the path P, a different thickness and effect compared to the remaining parts of the surface to be decorated.

The removal means 6 suitably remove the portions of granular material G which have not adhered to the layers S′ and S″ of adhesive material, and which therefore remain in excess as they cannot be incorporated into the decoration to be created.

In more detail, the removal means 6 of the granular material G comprises at least one suction hood 11.

The suction hood 11 is supported by the basic frame 2 at a suitable height with respect to the supporting surface 3, so that its suction port 11a is located in the proximity of the upper surface of the products P to be decorated. The suction hood 11 also comprises an exhaust port 11b through which, by means of suitable ducts not shown in the figures, the excess granular material G can be, e.g., sent back inside the hopper 7, or intended for a suitable collection area.

In other embodiments, the removal means 6 of the excess granular material G could be of another equivalent type.

For example, the removal means 6 may be of the mechanical type.

Advantageously, the supporting surface 3 is movable along a direction of forward movement 12 and the first head 4, the deposition means 5, the second head 9 and the removal means 6 are arranged in sequence with each other along the direction of forward movement 12.

In other words, the product P moving forward on the supporting surface 3 meets in sequence the first head 4, the deposition means 5, the second head 9 and the removal means 6.

More particularly, the supporting surface 3 may be of the type of a conveyor belt supported by the basic frame 2, on which the products P to be decorated are positioned in support.

In other embodiments of the machine 1 according to the invention, the supporting surface 3 could be of another equivalent type, e.g. roller, belt, or the like.

Preferably, the adhesive material used is of the type that is cured by exposure to radiation.

In more detail, the adhesive material of which the layer is made up is preferably of the low-viscosity type, which cures rapidly when subjected to radiation of a certain frequency.

In this way, the adhesive material very quickly takes on the form of a substantially transparent film with a sticky texture suitable for the subsequent deposition of materials.

Preferably, the machine 1 comprises first irradiation means 13 of the first layer S′ of adhesive material.

As explained above, the irradiation of the layer of adhesive material, for a suitably prefixed range of time, determines the rapid transformation thereof into a substantially transparent and sticky film suitable for the subsequent deposition of materials.

The first irradiation means 13 are interposed between the first head 4 and the deposition means 5.

More particularly, the first irradiation means 13 are arranged downstream of the first head 4 along the direction of forward movement 12.

Appropriately, the machine 1 also comprises second irradiation means 14 of the second layer S″ of adhesive material, which are interposed between the second head 9 and the removal means 6.

The second irradiation means 14 have the function of increasing the adhesion of the second layer S″ to the underlying granular material G and the first layer S′ and increasing the thickness of the decoration.

More particularly, the second irradiation means 14 are arranged downstream of the second head 9 along the direction of forward movement 12.

The second irradiation means 14 are preferably of the same type as the first irradiation means 13.

Preferably, the irradiation means 13, 14 comprise one or more light emitting lamps, e.g. of the ultraviolet type.

The lamps 13, 14 are supported by the basic frame 2 so as to have the radiating surface positioned in the proximity of the upper surface of the products P to be decorated.

In other embodiments, the irradiation means 13, 14 may comprise one or more light radiation emitting lamps having different frequencies, e.g., visible light or others, depending on the specific application requirements.

In a further embodiment, not shown in the figures, the machine 1 also comprises second deposition means of the granular material G on top of the second layer S″ of adhesive material.

More particularly, the second deposition means are interposed between the second head 9 and the removal means 6. Thus, the second deposition means are arranged downstream of the second head 9 with respect to the direction of forward movement 12.

Suitably, in this embodiment, the machine 1 also comprises a third digital printing head adapted to apply at least a third layer of fluid adhesive material on top of the granular material G deposited by the second deposition means.

The third digital printing head is interposed between the second deposition means and the removal means 6.

The second deposition means and the third printing head have the function of further increasing the thickness of the decoration made on the product P.

The operation of the machine mentioned above in the execution of the method according to the invention is as follows.

The method of the present invention comprises the supply of at least one product P to be decorated, e.g. of the type of a ceramic tile, a first application of at least a first layer S′ of fluid adhesive material on the surface of the product P to be decorated, followed by the deposition of the granular material G on the first layer S′.

As described above, the first application of the first layer S′ is carried out by means of the first digital printing head 4 and the deposition of the granular material G is carried out by means of the deposition means 5.

According to the invention, after the deposition of the granular material G there is a second application of at least a second layer S″ of fluid adhesive material on top of the deposited granular material G.

Advantageously, the second layer S″ is applied so as to overlap to the first layer S′, so as to incorporate the granular material G positioned between them. Therefore, in the event of the first application being carried out following a predefined path 10, the second application is, in turn, carried out following the same path 10.

Following the second application, a phase is carried out to remove the excess granular material G that has not adhered to the layers S′, S″ or has been deposited outside them.

The removal of excess granular material G is carried out by means of the removal means 6.

Preferably, after the first application, a first irradiation phase of the first layer S′ is carried out in order to transform it into a transparent, sticky film.

The first irradiation is carried out by means of the first irradiation means 13. Similarly, after the second application, a second irradiation phase of the second layer S″ can be carried out in order to optimize the adhesion thereof to the underlying granular material G and to the first layer S′.

The second irradiation phase is carried out by means of the second irradiation means 14.

It has in fact been ascertained that the described invention achieves the intended objects and in particular the fact is emphasized that the machine and the method to which the present invention relate, allow to vary the thickness of the visible surface of a product to be decorated, so as to obtain a textured surface or in any case an aesthetic effect of the material type, in an easy and practical manner.

In particular, the use of two layers of adhesive material between which the granular material is interposed makes it possible to fix and hold the granular material itself, thus ensuring adhesion to the product to be decorated, and at the same time to obtain and modulate the desired thickness.

1) A machine for the digital decoration of products with granular materials and the like, the machine comprising:
- a basic frame;
- at least one supporting surface for supporting at least one product to be decorated associated with said basic frame;
- at least a first digital printing head adapted to apply at least a first layer of fluid adhesive material on the surface of the product to be decorated;
- deposition means of a granular material on said first layer of adhesive material;
- removal means of the excess granular material; and
at least a second digital printing head adapted to apply at least a second layer of fluid adhesive material on top of the granular material, said second printing head being positioned between said deposition means and said removal means.

2) The machine according to claim 1, wherein said first printing head is adapted to apply said first layer of adhesive material according to a predefined path.

3) The machine according to claim 2, wherein said second printing head is adapted to apply said second layer of adhesive material according to said predefined path.

4) The machine according to claim 1, wherein said supporting surface is movable along a direction of forward movement, said first printing head, said deposition means, said second printing head said removal means being arranged in sequence along said direction of forward movement.

5) The machine according to claim 1, further comprising: first irradiation means of said first layer of adhesive material, said first irradiation means being interposed between said first printing head and said deposition means.

6) The machine according to claim 5, further comprising: second irradiation means of said second layer of adhesive material, said second irradiation means being interposed between said second printing head and said removal means.

7) The machine according to claim 1, wherein said deposition means comprise at least one hopper containing the granular material and a dispensing device of the granular material on said first layer of adhesive material.

8) The machine according to claim 7, wherein said hopper has at least one outlet port of the material and said dispensing device comprises at least one rotating element arranged below said outlet port.

9) The machine according to claim 8, wherein said rotating element is arranged at said outlet port and is operable in rotation so as to drag the granular material passing through said outlet port in a discordant direction to said direction of forward movement.

10) A method for the digital decoration of products with granular materials and the like, the method comprising:
- supply of at least one product to be decorated;
- first application of at least a first layer of fluid adhesive material on the surface of the product to be decorated;
- deposition of a granular material on said first layer; and
- removal of the excess granular material; wherein
after said first deposition, at least a second application of at least a second layer of fluid adhesive material on top of the deposited granular material.

11) The method according to claim 10, wherein said second application is carried out before said removal.

12) The method according to claim 11, wherein said first application is carried out following a predefined path.

13) The method according to claim 12, wherein said second application is carried out following said predefined path.

14) The method according to claim 10, wherein said first application is carried out following a predefined path.

15) The method according to claim 14, wherein said second application is carried out following said predefined path.

16) A machine for the digital decoration of products with granular materials and the like, the machine comprising:
- a basic frame;
- at least one supporting surface for supporting at least one product to be decorated associated with said basic frame;
- at least a first digital printing head adapted to apply at least a first layer of fluid adhesive material on the surface of the product to be decorated;
- a deposition device of a granular material on said first layer of adhesive material;
- a removal device of the excess granular material; and
- at least a second digital printing head adapted to apply at least a second layer of fluid adhesive material on top of the granular material, said second printing head being positioned between said deposition device and said removal device.
